(19) United States
(12) Patent Application Publication
(10) Pub. No.: US 2026/0353520 A1
(43) Pub. Date: Nov. 5, 2026

(54) INDUCTION HOB DEVICE

(71) Applicant: BSH Hausgeräte GmbH, Munich (DE)

(72) Inventors: Paul Muresan, La Cartuja (ES); Diego Puyal Puente, Zaragoza (ES); Nicolas Blasco Rueda, Zaragoza (ES); Javier Serrano Trullen, Zaragoza (ES); Arturo Acevedo Simon, Zaragoza (ES); Jorge Gaston Puig, Zaragoza (ES); Miguel Ángel Pradas López, Zaragoza (ES); Jorge Español Leza, Zaragoza (ES)

(21) Appl. No.: 19/486,074

(22) PCT Filed: May 28, 2024
(86) PCT No.: PCT/EP2024/064572

§ 371 Date: Nov. 20, 2025

(30) Foreign Application Priority Data
May 31, 2023 (EP) 23382515.7

(51) Int. Cl. H05B 6/06

(52) U.S. Cl. CPC H05B 6/062; H05B 2213/05

(57) ABSTRACT

An induction cooktop device includes a heating inductor and a detection unit having a self-oscillating oscillator circuit which measures in detection mode properties of an induction load of the heating inductor. The oscillator circuit includes a single transistor connected in common base, a feedback network which the heating inductor is part of in the detection mode, an induction coil connected to a collector terminal of the transistor, and a resistive voltage divider to which a base terminal of the transistor is connected to set a direct current operating point of the transistor to a value between 0 V and a supply voltage of the oscillator circuit. The oscillator circuit includes an electric resistor and a capacitor, each being electrically connected in series to the base terminal of the transistor and designed to set a base impedance in alternating current mode to ensure oscillation for a wide range of induction loads.

The invention relates to an induction cooktop device according to the preamble of claim 1.

Induction cooktops with heating inductors and with a detection unit for measuring properties of an induction load of the heating inductor, for example for pot detection, are already known from the prior art. In many instances the heating inductors are used as sensors, the heating inductors being subjected, in detection mode, to a high-frequency detection signal generated by a self-oscillating oscillator circuit of the detection unit, for example by a Colpitts oscillator. It should be ensured here that the frequencies of the detection signal are sufficiently removed from the natural resonant frequency of the heating inductor, as there may otherwise be a loss of oscillation and/or measurement deviations, in particular if a user moved the pot during measurement. The self-oscillating oscillator circuit must therefore be able to ensure a wide oscillation range in order to generate oscillating detection signals sufficiently removed from the natural resonant frequency of the heating inductor. For conventional heating inductors made of copper the oscillation range of the self-oscillating oscillator circuits known to date is still sufficiently wide to generate detection signals sufficiently removed from the natural resonant frequency of the heating inductor. If heating inductors made of aluminum are used instead of conventional heating inductors made of copper, which is desirable due to the much lower material costs, the oscillation range of the self-oscillating oscillator circuits known to date is too narrow to maintain a sufficient remove from the natural resonant frequency of the heating inductor, which is much lower in the case of aluminum. Measurement of properties of an induction load of a heating inductor using the heating inductor as a sensor is therefore not possible with induction cooktop devices known to date, which have conventional self-oscillating oscillator circuits, if the heating inductor is made of aluminum. This disadvantageously limits flexibility to a significant degree.

It is the object of the invention in particular, without being restricted hereto, to provide a generic device with improved properties in respect of flexibility. According to the invention the object is achieved by the features of claim 1, while advantageous embodiments and developments of the invention will emerge from the subclaims.

The invention is based on an induction cooktop device with at least one heating inductor and with a detection unit, which has at least one self-oscillating oscillator circuit, which is provided, in detection mode, to measure properties of an induction load of the heating inductor, and which has a single transistor, a feedback network, an induction coil and a resistive voltage divider, wherein the transistor is connected in common base, wherein the heating inductor, in detection mode, is part of the feedback network, wherein the induction coil is connected to a collector terminal of the transistor, wherein a base terminal of the transistor is connected to the resistive voltage divider, in order to set a direct current operating point of the transistor to a value between 0 V and a supply voltage of the oscillator circuit, in particular to half the supply voltage of the oscillator circuit.

It is proposed that the oscillator circuit has an electric resistor and a capacitor, which are each electrically connected in series to the base terminal of the transistor and are provided to set a base impedance in alternating current mode, to ensure oscillation for a wide range of induction loads.

Such an embodiment can advantageously provide an induction cooktop device with improved properties in respect of flexibility. A wider oscillation range can advantageously be achieved than with oscillation circuits known to date, which are used to measure properties of an induction load of a heating inductor. A larger current can also be fed into the heating inductor, advantageously increasing the noise immunity of signals. It is advantageously also possible to distinguish cooking utensil materials, in particular to distinguish between non-ferromagnetic materials and ferromagnetic materials, as it is possible to measure both the frequency and amplitude of the detection signal, the latter being associated with the equivalent resistance of the induction load.

The induction cooktop device is configured as a part, in particular a subassembly, of an induction cooktop. The induction cooktop device can also comprise the entire induction cooktop. The induction cooktop device comprises at least one heating inductor, which, in heating mode, supplies energy in the form of an electromagnetic alternating field to at least one object, in particular to a cooking utensil. The induction cooktop device could have at least two, in particular at last three, advantageously at least four, particularly advantageously at least five, preferably at least eight and particularly preferably multiple heating inductors, which could each supply energy inductively in heating mode, in particular to a single object or to at least two or more objects. At least some of the heating inductors could be arranged in proximity to each other, for example in a row and/or in the form of a matrix. The induction cooktop device can have an inverter unit with at least two inverter switching elements to supply energy to the at least one heating inductor. Alternatively the inverter unit can also be part of an induction cooktop comprising the induction cooktop device. The inverter switching elements of the inverter unit here can be configured as semiconductor switching elements, in particular as transistors, for example as metal oxide semiconductor field-effect transistors (MOSFET) or organic field-effect transistors (OFET), advantageously as bipolar transistors preferably with an insulated gate electrode (IGBT).

The detection unit is provided to measure properties of an induction load of the heating inductor, for example and without restriction hereto, to measure the presence of an object, in particular a cooking utensil or a metal foreign object, above the heating inductor and/or to measure a degree of cover of the heating inductor by the object and/or to measure material properties of the object and/or the like. To this end the detection unit has the self-oscillating oscillator circuit, which is provided, in detection mode, to measure properties of the induction load of the heating inductor. The self-oscillating oscillator circuit is provided, in detection mode, to generate a detection signal and to apply the detection signal to the heating inductor, the heating inductor being part of the feedback network of the self-oscillating oscillator circuit. The induction load of the heating inductor here can be characterized by the equivalent inductance and the electrical equivalent resistance of the heating inductor, the equivalent inductance and the electric equivalent resistance of the heating inductor being a function of the presence of a metal object, for example a cooking utensil, above the heating inductor, as well as the shape, size, position and material of the object. As the heating inductor is part of the feedback network of the self-oscillating oscillator circuit, the induction load of the heating inductor influences the frequency of the oscillating detection signal, which can be picked up as an output signal at a measuring output of the self-oscillating oscillator circuit. The detection unit preferably has a scanning unit, which is connected to the measuring output of the self-oscillating oscillator circuit and is provided to further process the output signal. The measuring output of the self-oscillating oscillator circuit is preferably connected to an emitter terminal of the single transistor of the self-oscillating oscillator circuit. The transistor is connected in common base, with the result that the transistor advantageously has a low input impedance and a high output impedance. A further advantage of the common base of the transistor is that there is no phase shift between transistor input and output in this configuration, with the result that the phase condition according to the stability criteria of Barkhausen and Nyquist is met. The transistor is preferably configured as a bipolar transistor, preferably an NPN bipolar transistor. Alternatively the transistor could also be configured as a field-effect transistor, for example a MOSFET, preferably an n-channel MOSFET, which is then connected in a gate circuit equivalent to a common base.

The self-oscillating oscillator circuit also has the resistive voltage divider, which is connected to the base terminal of the transistor and is provided to set the direct current operating point of the transistor to a value between 0 V and the supply voltage of the oscillator circuit, in particular to half the supply voltage of the oscillating circuit. The resistive voltage divider has at least two, preferably just two, electric resistors, the values of which are selected to set the direct current operating point of the transistor to half the supply voltage of the oscillator circuit. The self-oscillating oscillator circuit preferably has a direct current voltage, which is provided to supply the supply voltage and is connected to the resistive voltage divider.

The self-oscillating oscillator circuit also has the induction coil, which is connected to the collector terminal of the transistor. The induction coil preferably connected to the direct current voltage and is provided to open up a direct current path to the collector terminal of the transistor and to block an alternating current path between the collector terminal and the base terminal of the transistor.

The oscillator circuit has the electric resistor and the capacitor, which are each electrically connected in series to the base terminal of the transistor and are provided to set the base impedance in alternating current mode, to ensure oscillation for a wide range of induction loads. A capacitance of the capacitor, which is electrically connected in series to the base terminal of the transistor, is selected such that the capacitor has a high impedance for direct current, so the direct current operating point of the transistor is set by the resistive voltage divider alone. At the same time the capacitance of the capacitor, which is electrically connected in series to the base terminal of the transistor, is selected such that the capacitor forms a short circuit path for alternating currents with a frequency in an operating frequency range of the detection unit, so that the base impedance of the transistor is determined, in alternating current mode, by the electric resistor, which is electrically connected in series to the base terminal of the transistor. The base terminal of the transistor is preferably connected to the emitter terminal of the transistor by way of the electric resistor connected in series there and the capacitor. In oscillator circuits known to date the base terminal of the transistor is in contrast often connected to ground by way of a capacitor, which results in a fixed detection signal frequency and is therefore not suitable for applications for measuring properties of the induction load of the heating inductor. Tests by the applicant have shown that the oscillation range of the self-oscillating oscillator circuit can be enlarged surprisingly when the electric resistor is connected in series to the base terminal of the transistor.

“At least essentially” in this document means that a deviation from a predetermined value deviates in particular by less than 25%, preferably less than 10% and particularly preferably less than 5% of the predetermined value.

In the present document numerical values, for example “first” and “second”, before specific terms only serve to distinguish between objects and/or to rank objects and do not imply any total number and/or sequence of said objects. In particular a “second object” does not necessarily imply the presence of a “first object”.

“Provided” means specifically programmed, designed and/or equipped. That an object is provided for a specific function means that the object fulfils and/or performs said specific function in at least one use and/or operating state.

It is further proposed that the electric resistor, which is electrically connected in series to the base terminal of the transistor, has a value, which is smaller at least by a factor 2 than the values of the electric resistors which form the resistive voltage divider. This advantageously increases flexibility further. In particular the oscillation range of the self-oscillating oscillator circuit can advantageously be further increased. The electric resistor, which is electrically connected in series to the base terminal of the transistor, has a value which is smaller, advantageously at least by a factor 3, preferably at least a factor 4 and preferentially at least a factor 5, than the values of the electric resistors which form the resistive voltage divider. For example the electric resistors forming the resistive voltage divider can each have a value of 1 kΩ and the electric resistor electrically connected in series to the base terminal of the transistor can have a value of 200Ω.

It is also proposed that the electric resistor, which is electrically connected in series to the base terminal of the transistor, has a value of at least 40Ω and maximum 250Ω. This advantageously increases flexibility further. It advantageously ensures oscillation for a particularly wide spectrum of cooking utensils with different material properties. The electric resistor, which is electrically connected in series to the base terminal of the transistor, in particular has a value of at least 45Ω and maximum 240Ω, advantageously a value of at least 50Ω and maximum 230Ω, particularly advantageously a value of at least 55Ω and maximum 230Ω, preferably a value of at least 60Ω and maximum 220Ω, preferentially a value of at least 65Ω and maximum 210Ω and particularly preferentially a value of 200Ω.

It is further proposed that the capacitor, which is electrically connected in series to the base terminal of the transistor, has a capacitance of 100 nF. Such an embodiment advantageously increases the reliability of the induction cooktop device. It can be ensured in particular that the capacitor, which is electrically connected in series to the base terminal of the transistor, has a high impedance for direct current and a low impedance for alternating currents with a frequency in the operating frequency range of the detection unit. Alternatively the capacitor, which is electrically connected in series to the base terminal of the transistor, can also have a capacitance of less than 100 nF or more than 100 nF, as long as it has a sufficiently high impedance for direct current and a sufficiently low impedance for alternating currents with a frequency in the operating frequency range of the detection unit.

It is further proposed that the oscillator circuit has two capacitors, which are arranged between the collector terminal and the emitter terminal of the transistor and form a capacitive voltage divider. Such an embodiment advantageously results in a simple oscillator circuit structure. The oscillator circuit can be configured as a Collpits oscillator, if it has the two capacitors arranged between the collector terminal and the emitter terminal of the transistor and forming the capacitive voltage divider. The measuring output of the oscillator circuit is preferably connected to a center point of the capacitive voltage divider. This advantageously improves measurement accuracy, as the capacitive voltage divider also acts as a high pass filter, filtering out low-frequency noise from the heating inductor, which can otherwise mask the output signal. The capacitances of the two capacitors, which form the capacitive voltage divider, are selected such that an oscillation in the operating frequency range of the detection unit is ensured, in other words the amplitude condition according to the stability criteria of Barkhausen and Nyquist is met.

It is also proposed that the oscillator circuit has a further capacitor, which is electrically connected in series to the collector terminal of the transistor and which is electrically connected in series to the heating inductor in detection mode. This advantageously increases flexibility further. The oscillator circuit can be configured as a Clapp oscillator, if it has the further capacitor, which is electrically connected in series to the collector terminal of the transistor and which is electrically connected in series to the heating inductor at least in detection mode. The further capacitor advantageously allows the frequency of the detection signal to be set more accurately. The further capacitor also advantageously allows capacitive decoupling of the detection unit from the heating inductor in heating mode by particularly simple technical means. This can be achieved by selecting a capacitance of the further capacitance such that the further capacitor has a high impedance for alternating current in the range up to 100 kHz, with which the heating inductor is supplied with energy by the inverter unit in heating mode, and a low impedance for alternating currents in the operating frequency range of the detection unit, which comprises frequencies above 500 kHz.

In a particularly advantageous embodiment of the invention it is proposed that the further capacitor has a capacitance which is smaller at least by a factor 10 than the capacitances of the capacitors forming the capacitive voltage divider. This advantageously allows the frequency of the detection signal to be set even more accurately, as the dependence of the frequency of the detection signal on the capacitances of the two capacitors forming the capacitive voltage divider is further reduced. The further capacitor in particular has a capacitance which is smaller at least by a factor 20, advantageously at least by a factor 50, particularly advantageously at least by a factor 100, preferably at least by a factor 500, preferentially at least by a factor 1,000 and particularly preferentially at least by a factor 10,000 than the capacitances of the capacitors forming the capacitive voltage divider. The capacitors forming the capacitive voltage divider can each have a capacitance of 1 nF, for example but without being restricted hereto, and the further capacitor can have a capacitance of 10 pF, for example but without being restricted hereto.

It is further proposed that the heating inductor is made at least largely of aluminum. Such an embodiment advantageously improves efficiency, in particular cost efficiency, as aluminum can be obtained at much lower cost than copper, which is conventionally used for heating inductors in induction cooktops. In combination with the inventive induction cooktop device, it is thus possible to provide a particularly low-cost induction cooktop, which also offers a particularly high degree of operating convenience, as it is also possible to measure properties of an induction load of the heating inductor when said heating inductor is made at least largely of aluminum. The heating inductor is made in particular at least largely of more than 50% by weight, advantageously at least largely of more than 60% by weight, particularly advantageously at least largely of more than 70% by weight, preferably at least largely of more than 80% by weight and preferentially at least largely of more than 90% by weight of aluminum. For example the heating inductor could be made of an alloy of aluminum and copper with a percentage of aluminum of more than 50% by weight. The heating inductor is particularly preferably made completely of aluminum.

It is also proposed that the heating inductor has an equivalent inductance of at least 20 pH and maximum 120 μH, an electric equivalent resistance of maximum 200Ω and a parasitic capacitance of maximum 150 pF. This advantageously increases flexibility still further. It can be ensured that oscillation takes place, in particular for all cooking utensils currently available on the market, which may be made of a wide range of different metallic materials, thereby allowing the measurement of properties of the induction load of the heating inductor, if the heating inductor has an equivalent inductance of at least 20 μH and maximum 120 μH and an electric equivalent resistance of maximum 200Ω and a parasitic capacitance of maximum 150 pF.

It is further proposed that the induction coil has an inductance which is selected such that the induction coil offers a low impedance for direct currents and a high impedance for alternating currents with a frequency in an operating frequency range of the detection unit. This advantageously ensures reliable operation of the oscillator circuit. The induction coil in particular has an inductance of at least 0.5 mH and maximum 1.5 mH, advantageously an inductance of at least 0.6 mH and maximum 1.4 mH, particularly advantageously an inductance of at least 0.7 mH and maximum 1.3 mH, preferably an inductance of at least 0.8 mH and maximum 1.2 mH, preferentially an inductance of at least 0.9 mH and maximum 1.1 mH and particularly preferably an inductance of 1.0 mH.

It is further proposed that the oscillator circuit has a protective diode, the anode of which is connected to an emitter terminal and the cathode of which is connected to the base terminal of the transistor. This advantageously improves safety. In particular it prevents damage to the transistor due to excess voltage. The protective diode is connected from the emitter terminal in the direction of the base terminal in the direction of passage and is provided to protect the transistor against excess voltage.

The invention also relates to an induction cooktop with at least one induction cooktop device according to one of the embodiments described above. Such an induction cooktop is characterized in particular by its advantageous properties in respect of a high level of flexibility and efficiency, as achieved by the induction cooktop device.

The induction cooktop device here is not restricted to the application and embodiment described above. In particular the induction cooktop device can have a different number of individual elements, parts and units from the number cited herein to comply with a mode of operation described herein.

Further advantages will emerge from the description of the figures that follows. The drawing shows an exemplary embodiment of the invention. The drawing, description and claims contain numerous features in combination. The person skilled in the art will expediently also consider the features individually and combine them in useful further combinations.

In the drawing:

FIG. 1 shows a schematic diagram of an induction cooktop with an induction cooktop device comprising at least one heating inductor and a detection unit,

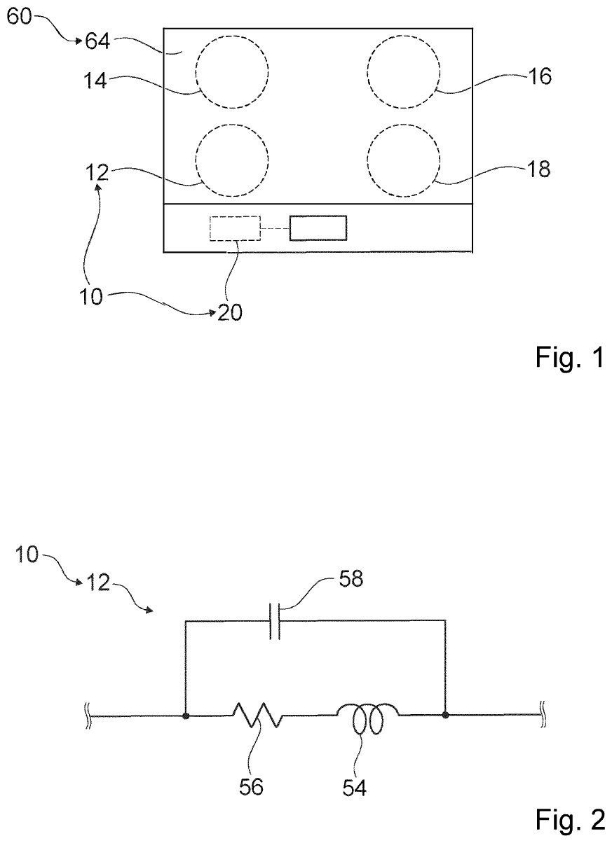

FIG. 2 shows a schematic electric equivalent circuit diagram of the heating inductor,

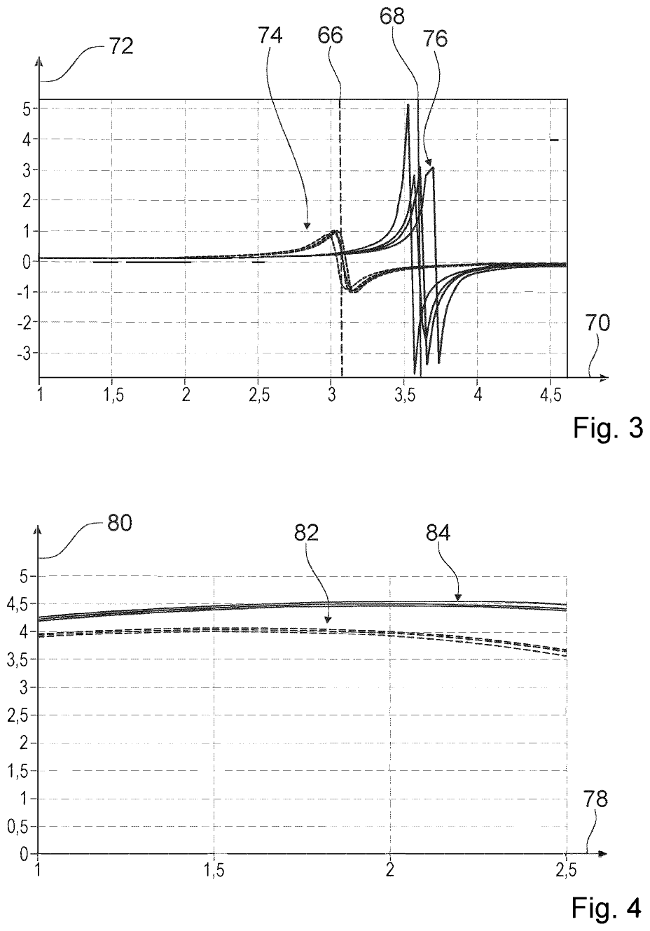

FIG. 3 shows a schematic diagram showing a natural resonant frequency of the heating inductor of the induction cooktop device compared with a natural resonant frequency of a conventional heating inductor,

FIG. 4 shows a schematic diagram showing quality factors of the heating inductor of the induction cooktop device compared with quality factors of the conventional heating inductor,

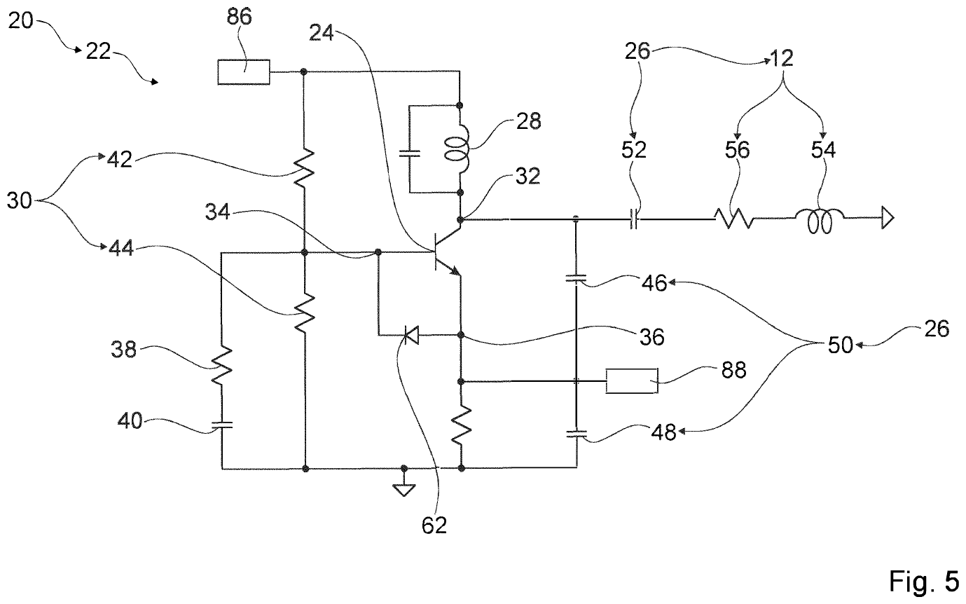

FIG. 5 shows a schematic electric circuit diagram of a self-oscillating oscillator circuit of the detection unit and

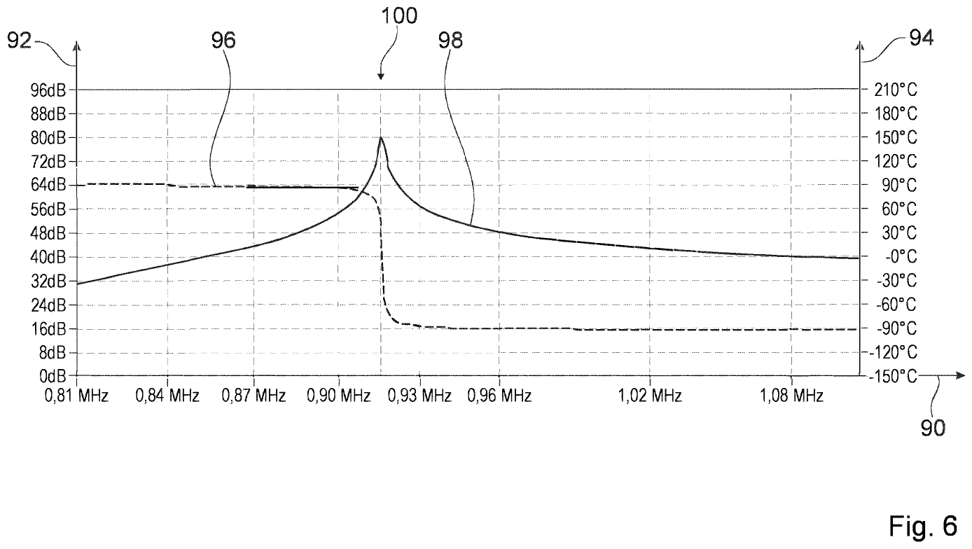

FIG. 6 shows a schematic diagram showing a frequency and phase response of the self-oscillating oscillator circuit.

FIG. 1 shows a schematic diagram of an induction cooktop 60. The induction cooktop 60 comprises an induction cooktop device 10. The induction cooktop device 10 comprises at least one heating inductor 12. The induction cooktop device 10 here comprises the heating inductor 12 and three further heating inductors 14, 16, 18. The heating inductors 12, 14, 16, 18 are arranged below a cooktop plate 64 of the induction cooktop 60 and are provided, in heating mode, to supply energy in the form of an electromagnetic alternating field to at least one object (not shown), for example a cooking utensil, on the cooktop plate 64. The induction cooktop device 10 is not restricted to four heating inductors 12, 14, 16, 18 but could have any number of heating inductors 12, 14, 16, 18 greater than or equal to one, without departing from the scope of the present invention.

The induction cooktop device 10 comprises a detection unit 20. The detection unit 20 has a self-oscillating oscillator circuit 22 (see FIG. 5), which is provided in detection mode to measure properties of an induction load of the heating inductor 12. The self-oscillating oscillator circuit 22 here is also provided to measure properties of induction loads of the further heating inductors 14, 16, 18. The induction cooktop device 10 can have a multiplexer circuit (not shown), which is provided to connect the detection unit 20 to the heating inductors 12, 14, 16, 18 one after the other for detection mode and to break the connection between the detection unit 20 and the heating inductors 12, 14, 16, 18 for a heating mode of the heating inductors 12, 14, 16, 18. In heating mode the heating inductors 12, 14, 16, 18 are each operated by an inverter unit (not shown) of the induction cooktop device 10.

FIG. 2 shows a schematic electric equivalent circuit diagram of the heating inductor 12. The heating inductor 12 is made at least largely of aluminum. The heating inductor 12 here is made completely of aluminum. The heating inductor 12 has an equivalent inductance 54, an electric equivalent resistance 56 and a parasitic capacitance 58, as shown in the equivalent circuit diagram in FIG. 2. The heating inductor 12 here has the equivalent inductance 54 of at least 20 μH and maximum 120 μH. The heating inductor 12 here has the equivalent resistance 56 of maximum 200Ω. The heating inductor 12 here has the parasitic capacitance 58 of maximum 150 pF. The further heating inductors 14, 16, 18 here have essentially the same properties as the heating inductor 12.

FIG. 3 shows a schematic diagram showing a natural resonant frequency 66 of the heating inductor of the induction cooktop device 10 compared with a natural resonant frequency 68 of a conventional heating inductor (not shown). A frequency of a detection current in megahertz is shown on an x-axis 70 of the diagram. A natural inductance in milihenry is shown on a y-axis 72 of the diagram. A series of measurements 74 in the diagram shows a pattern of the natural inductance of the heating inductor 12 when stimulated with detection currents with frequencies in the megahertz range. A series of measurements 76 in the diagram shows a pattern of the natural inductance of the conventional heating inductor when stimulated with detection currents with frequencies in the megahertz range. In contrast to the heating inductor 12 the conventional inductor is made essentially of copper but otherwise has essentially identical geometry and essentially identical dimensions to the heating inductor 12. The measurements shown in the diagram were performed with the same cooking utensil (not shown) in each case, positioned above the heating inductor 12 or above the conventional inductor. As shown in the diagram the natural resonant frequency 66 of the heating inductor 12 is much lower than the natural resonant frequency 68 of the conventional heating inductor, due to the use of the different materials. If the detection current has a frequency in the range of the natural resonant frequency 66 of the heating inductor 12 or in the range of the natural resonant frequency 68 of the conventional heating inductor, this can cause various problems, inter alia a loss of oscillation and/or measurement deviations, if the pot is moved by a user during measurement, causing the parasitic capacitance of the system to be increased. It is therefore desirable for the detection current to have a frequency which is far enough removed from the respective natural resonant frequencies 66, 68. This is easily possible for conventional heating inductors due to the higher natural resonant frequency 68 with oscillator circuits known to date. For inductors which, like the heating inductor 12, are made at least largely of aluminum, a wider oscillation spectrum is required to allow reliable detection, which was not possible with oscillator circuits known to date.

A further challenge when using aluminum rather than copper as the material for the heating inductor 12 is the quality factor. The quality factor is given by the following formula 1:

$$Q = ω \frac{{L}_{e q}}{{R}_{e q}} \qquad ( 1 )$$

where Q is the quality factor, ω the angular frequency, L_{eq} the equivalent inductance and R_{eq} the electric equivalent resistance. The angular frequency ω is calculated using the following formula 2:

ω=2πf (2)

where π is pi and f is the frequency of the detection current.

FIG. 4 shows a schematic diagram showing quality factors of the heating inductor 12 of the induction cooktop device 10 compared with quality factors of the conventional heating inductor. A frequency in megahertz is shown on an x-axis 78 of the diagram. The quality factor is shown as a dimensionless variable on a y-axis 80 of the diagram. A series of measurements 82 shows a pattern of the quality factor of the heating inductor 12 as a function of the frequency of the detection current. A series of measurements 84 shows a pattern of the quality factor of the conventional heating inductor as a function of the frequency of the detection current. As shown in the diagram, the conventional heating inductor has a higher quality factor than the heating inductor 12 over the entire frequency range. An amplitude of a sinusoidal output signal of the oscillator circuit used here is a function inter alia of the quality factor, so the amplitude of the output signal when measuring properties of an induction load of the heating inductor 12 is smaller than for the conventional heating inductor when a conventional oscillator circuit is used. This can mean that a signal to noise ratio is too small and measurements are correspondingly inaccurate.

The disadvantages described above with reference to FIGS. 3 and 4, which result in respect of the measurement of properties of induction loads when inductors made of aluminum are used as heating conductors in induction cooktops, can be overcome by the self-oscillating oscillator circuit 22 of the detection unit 20 of the induction cooktop device 10.

FIG. 5 shows a schematic electric circuit diagram of the self-oscillating oscillator circuit 22. The oscillator circuit 22 comprises a single transistor 24, a feedback network 26, an induction coil 28 and a resistive voltage divider 30.

The transistor 24 has a collector terminal 32, a base terminal 34 and an emitter terminal 36. The transistor 24 is connected in common base. The oscillator circuit 22 here has a protective diode 62, the anode of which is connected to the emitter terminal 36 and the cathode of which is connected to the base terminal 34 of the transistor 24. The protective diode 62 is therefore connected from the emitter terminal 36 in the direction of the base terminal 34 in the direction of passage. The protective diode 62 is provided to protect the transistor 24 against excess voltage.

In detection mode the heating inductor 12 is part of the feedback network 26. In the electric circuit diagram in FIG. 5 the heating inductor 12 is represented by its equivalent inductance 54 and its electric equivalent resistance 56. The parasitic capacitance 58 (see FIG. 2) is not shown in FIG. 5 for simplification.

The induction coil 28 is connected to the collector terminal 32 of the transistor 24. The induction coil 28 has an inductance which is selected such that the induction coil 28 offers a low impedance for direct currents and a high impedance for alternating currents with a frequency in an operating frequency range of the detection unit 20. The induction coil 28 here has an inductance of 1.0 mH.

The oscillator circuit 22 has two electric resistors 42, 44, which form the resistive voltage divider 30. The base terminal 34 of the transistor 24 is connected to the resistive voltage divider 30 to set a direct current operating point of the transistor 24 to half a supply voltage of the oscillator circuit 22. The electric resistors 42, 44 therefore have the same values. The induction cooktop device 10 here has a direct current voltage source 86 to supply the supply voltage for the oscillator circuit 22. The transistor 24 is connected to the direct current voltage source 86 by way of its collector terminal 32 and by way of the induction coil 28. The transistor 24 is also connected to the direct current voltage source 86 by way of its base terminal 34 by way of the resistive voltage divider 30.

The oscillator circuit 22 has an electric resistor 38 and a capacitor 40, which are each electrically connected in series to the base terminal 34 of the transistor. The electric resistor 38 and the capacitor 40 are provided to set a base impedance in alternating current mode, to ensure oscillation for a wide range of induction loads. The electric resistor 38, which is electrically connected in series to the base terminal 34 of the transistor 24, has a value which is smaller at least by a factor 2 than the values of the electric resistors 42, 44 which form the resistive voltage divider 30. The electric resistor 38, which is electrically connected in series to the base terminal 34 of the transistor 24, has a value of at least 40Ω and maximum 250Ω. The electric resistor 38 here has a value of 200Ω. The electric resistors 42, 44 here each have a value of 1 kΩ, so the value of the electric resistor 38 here is smaller by a factor 5 than the values of the electric resistors 42, 44.

The capacitor 40, which is electrically connected in series to the base terminal 34 of the transistor 24, has a capacitance of 100 nF. The capacitor 40 therefore has a high impedance for direct current so the direct current operating point of the transistor 24 is set by the resistive voltage divider 30 alone. For alternating currents with a frequency in the operating frequency range of the detection unit 20 the capacitor 40 in contrast forms a short circuit path, so that the base impedance of the transistor is determined, in alternating current mode, by the electric resistor 38.

The oscillator circuit 22 has two capacitors 46, 48, which are arranged between the collector terminal 32 and the emitter terminal 36 of the transistor 24 and form a capacitive voltage divider 50. The capacitors 46, 48 are part of the feedback network 26. A measuring output 88 of the oscillator circuit 22 is arranged between the capacitor 46 and the capacitor 48. This arrangement of the measuring output 88 causes low-frequency noise to be filtered. The capacitances of the capacitors 46, 48 are selected such that the amplitude condition according to the stability criteria of Barkhausen and Nyquist, as known to the person skilled in the art, is met. As the transistor 24 is connected in common base and the base, as a common reference point, brings about a phase shift of 0°, the feedback network 26 also brings about a phase shift of 0°, so the phase condition according to the stability criteria of Barkhausen and Nyquist is also met

The oscillator circuit 22 also has a further capacitor 52, which is electrically connected in series to the collector terminal 32 of the transistor 24 and which is electrically connected in series to the heating inductor 12, at least in detection mode. The oscillator circuit 22 here is therefore a variant of a Clapp oscillator. The oscillation frequency of the oscillation circuit 22 is determined here by the further capacitor 52. The further capacitor 52 has a capacitance, which is smaller at least by a factor 10 than the capacitances of the capacitors 46, 48, which form the capacitive voltage divider 50.

FIG. 6 shows a schematic diagram showing an exemplary frequency and phase response of the self-oscillating oscillator circuit 22. A frequency in megahertz is shown on an x-axis 90 of the diagram. A signal strength in decibels is shown on a first y-axis 92 of the diagram. A phase position in ° is shown on a second y-axis 94 of the diagram. A curve 96 in the diagram shows a pattern of the phase response. A curve 98 in the diagram shows a pattern of a signal strength of a signal in the oscillator circuit 22 as a function of frequency. The capacitors 46, 48, 52 are discharged at the start of detection mode. As soon as the voltage source 86 is activated, the capacitors 46, 48, 52 are charged by way of the induction coil 28. It is not necessary here for the capacitors 46, 48, 52 to be fully charged before oscillation can start. The transistor 24 operates in an amplifier mode at the start of detection mode. As in any electronic circuit there is also a small noise signal present in the oscillator circuit 22, which is amplified by the transistor 24 but only at a specific frequency, which is shown in the diagram in FIG. 6 as the operating frequency 100 of the detection unit 20. So that oscillation can start, the stability criteria of Barkhausen and Nyquist have to be met and the amplification factor of the transistor 24 must have a value greater than 1 and a phase shift between the input, in this instance the emitter terminal 36, and the output, in this instance the collector terminal 32, of the transistor 24 must have a value of 0°, given here for the operating frequency 100. The operating frequency 100 here is for example 0.915 MHz. As the heating inductor 12 is part of the feedback network 26, the value of the operating frequency 100 is a function inter alia of both properties of the induction load of the heating inductor 12, in other words for example the material properties, shape and size, and the positioning of a cooking utensil above the heating inductor 12.

### REFERENCE CHARACTERS

10 Induction cooktop device
12 Heating inductor
14 Further heating inductor
16 Further heating inductor
18 Further heating inductor
20 Detection unit
22 Self-oscillating oscillator circuit
24 Transistor
26 Feedback network
28 Induction coil
30 Resistive voltage divider
32 Collector terminal
34 Base terminal
36 Emitter terminal
38 Electric resistor
40 Capacitor
42 Electric resistor
44 Electric resistor
46 Capacitor
48 Capacitor
50 Capacitive voltage divider
52 Further capacitor
54 Equivalent inductance
56 Electric equivalent resistance
58 Parasitic capacitance
60 Induction cooktop
62 Protective diode
64 Cooktop plate
66 Natural resonant frequency
68 Natural resonant frequency
70 x-axis
72 y-axis
74 Series of measurements
76 Series of measurements
78 x-axis
80 y-axis
82 Series of measurements
84 Series of measurements
86 Direct current voltage source
88 Measuring output
90 x-axis
92 First y-axis
94 Second y-axis
96 Curve
98 Curve
100 Operating frequency

1-12. (canceled)

13. An induction cooktop device, comprising:
a heating inductor; and
a detection unit comprising a self-oscillating oscillator circuit, which is designed to measure in a detection mode a property of an induction load of the heating inductor, said self-oscillating oscillator circuit comprising a single transistor connected in common base, a feedback network which the heating inductor is part of in the detection mode, an induction coil connected to a collector terminal of the transistor, and a resistive voltage divider to which a base terminal of the transistor is connected to set a direct current operating point of the transistor to a value between 0 V and a supply voltage of the self-oscillating oscillator circuit,
wherein the self-oscillating oscillator circuit comprises an electric resistor and a capacitor, which are each electrically connected in series to the base terminal of the transistor and are designed to set a base impedance in alternating current mode so as to ensure oscillation for a wide range of induction loads.

14. The induction cooktop device of claim 13, wherein the resistive voltage divider is formed by electric resistors, said electric resistor of the self-oscillating oscillator circuit having a value, which is smaller at least by a factor 2 than values of the electric resistors of the resistive voltage divider.

15. The induction cooktop device of claim 13, wherein the electric resistor has a value of at least 40Ω and a maximum of 250Ω.

16. The induction cooktop device of claim 13, wherein the capacitor has a capacitance of 100 nF.

17. The induction cooktop device of claim 13, wherein the self-oscillating oscillator circuit comprises two capacitors, which are arranged between the collector terminal and an emitter terminal of the transistor and form a capacitive voltage divider.

18. The induction cooktop device of claim 13, wherein the self-oscillating oscillator circuit comprises a further capacitor, which is electrically connected in series to the collector terminal of the transistor and which is electrically connected in series to the heating inductor in the detection mode.

19. The induction cooktop device of claim 18, wherein the self-oscillating oscillator circuit comprises two capacitors, which are arranged between the collector terminal and an emitter terminal of the transistor and form a capacitive voltage divider, said further capacitor having a capacitance which is smaller at least by a factor 10 than capacitances of the two capacitors forming the capacitive voltage divider.

20. The induction cooktop device of claim 13, wherein the heating inductor is made at least largely of aluminum.

21. The induction cooktop device of claim 20, wherein the heating inductor has an equivalent inductance of at least 20 μH and a maximum of 120 μH, an electric equivalent resistance of maximum 200Ω and a parasitic capacitance of maximum 150 pF.

22. The induction cooktop device of claim 13, wherein the induction coil has an inductance which is selected such that the induction coil offers a low impedance for direct currents and a high impedance for alternating currents with a frequency in an operating frequency range of the detection unit.

23. The induction cooktop device of claim 13, wherein the self-oscillating oscillator circuit comprises a protective diode including a cathode connected to the base terminal of the transistor, and an anode connected to an emitter terminal of the transistor.

24. An induction cooktop, comprising the induction cooktop device of claim 13.
